(19) United States
(12) Patent Application Publication
(10) Pub. No.: US 2013/0183949 A1
(43) Pub. Date: Jul. 18, 2013

(54) SYSTEMS AND METHODS FOR HOSTING ANONYMOUS VIRTUAL PHONE CALLS, TEXT (SMS) MESSAGES, AND MULTI-MEDIA (MMS) MESSAGES

(71) Applicant: HotLynx LLC, Lexington, MA (US)

(72) Inventor: Joseph John Sulmar, Lexington, MA (US)

(73) Assignee: HOTLYNX LLC, Lexington, MA (US)

(21) Appl. No.: 13/739,548

(22) Filed: Jan. 11, 2013

Related U.S. Application Data
(60) Provisional application No. 61/586,666, filed on Jan. 13, 2012.

(51) Int. Cl. H04M 1/57

(52) U.S. Cl. CPC H04M 1/571
USPC 455/415

(57) ABSTRACT

A method and system for providing anonymous virtual sessions between users, e.g., subscribers and guests, in a manner enabling the actual network addresses and identities of both users to remain unknown to each other. This system is optionally integrated with conventional call centers for the purposes of synchronization, authorization of services, and billing. The method and system embody sessions such as phone calls, text, and multi-media using network addresses and virtual phone numbers in a manner that provides mutual anonymity by masking the actual network address of all end points from all participating end users.

### RELATED APPLICATION

This application claims priority to, and the benefit of, co-pending U.S. Provisional Application Ser. No. 61/586,666, filed Jan. 13, 2012, for all subject matter common to both applications. The disclosure of said provisional application is hereby incorporated by reference in its entirety.

### FIELD OF THE INVENTION

The present invention relates to communication networks suitable for hosting communication sessions such as phone calls, texts, and multi-media messages, and more particularly to hosting anonymous communication sessions between users.

### BACKGROUND OF THE INVENTION

Communication networks provide communication sessions between users in the form of voice calls, text, multi-media messages, and data exchanges, hereafter collectively referred to as “sessions.” Telephone networks provide such communications by establishing connections and transmission facilities between or among physical end points. An end point might be a physical location such as a home or office, or it may be a handheld device such as a mobile phone. Telephone numbers or, in the case of voice over IP networks, VOIP addresses, are employed as network addresses. Typically, a destination network address is specified at the origination point, and such network address uniquely identifies the desired termination point, thus enabling the network to establish effective point-to-point connections.

Network addresses are included in telephone networks that employ various internal methods including PSTN (public switched telephone network, also known as circuit switched) and VOIP (voice over IP). Regardless of the internal method, unique network addresses are associated with specific end points. End points are usually provisioned on behalf of specific users so a particular network address serves not only to identify an end point but also identifies the user. Information relating network addresses and identities of respective users is usually available to the public.

A user who originates a session must know the network address of the desired termination point, and the user at the termination point can usually learn the network address of the origination point through a feature of the network that conveys this information (such as caller ID). Using publicly available databases and/or knowing the network addresses, each user can learn the identities of other users. Malicious users could abuse this information to harass or invade the privacy of other users. This issue has not been adequately addressed or solved by conventional technology.

### SUMMARY

There is a need for systems and methods for providing anonymous sessions such as phone calls and messages between users in a manner enabling the actual network addresses and identities of both users to remain unknown to each other. Furthermore, there is a need for systems and methods for carrying anonymous sessions, such as phone calls and messages, and optionally integrating such services with conventional call centers for the purposes of synchronization, authorization of services, and billing. The present invention is directed toward solutions to address these and other needs, in addition to having other desirable characteristics that will be appreciated by one of skill in the art upon reading the present specification.

The present invention provides a means of establishing and conducting sessions over a network such as a telephone network using network addresses and virtual phone numbers in a manner that provides mutual anonymity by masking the actual network address of all end points from all participating end users. At least one user participating in an anonymous session must pre-subscribe to the virtual network service (the “subscriber”), and other participating users are “guests”. In certain embodiments, an operator working at home or at a call center might subscribe to the virtual network service, and customers of the call center might participate in the role of guest.

In accordance with an embodiment of the present invention, a computer-implemented method includes receiving, through an interface module, a call to a virtual phone number from a guest device having a guest network address. Using an identification module, a unique identification is determined and associated with the guest network address. Through communication using the interface module, a determination is made as to whether a subscriber device associated with the virtual phone number is available to receive a virtual session. The unique identification is transmitted, through the interface module, to the subscriber device associated with the virtual phone number. The virtual session is hosted, on the interface module, between the subscriber device and the guest device. Upon initiation of the virtual session, an indication that the subscriber device is not available is outputted through the interface module.

In accordance with aspects of the present invention, the virtual session is integrated with a call center to provide synchronization. In a further embodiment, the availability of the subscriber device is determined by a status of an existing virtual session combined with information from the call center which communicates with the interface module.

In accordance with aspects of the present invention, the virtual session is integrated with a call center to authorize billing and/or accounting. Alternatively, the virtual session is integrated with a call center to authorize a service.

In accordance with aspects of the present invention, the virtual session is a telephone communication. Alternatively, the virtual session is a text message (SMS). Alternatively, the virtual session is a multi-media message (MMS). Alternatively, the virtual session is a data transmission.

In accordance with aspects of the present invention, the unique identification is a distinctive number for each virtual phone number. In a further embodiment, the determination of the unique identification associated with the guest network address is created when the guest network address is first used with the virtual phone number.

In accordance with aspects of the present invention, the unique identification associated with the guest network address and the virtual phone number associated with the subscriber device are stored on one or more databases.

In accordance with aspects of the present invention, the guest network address is a telephone number.

In accordance with an embodiment of the present invention, a computer-implemented method includes receiving, through an interface module, a call to a virtual phone number from a subscriber device associated with the virtual phone number. The subscriber device is authenticated as the subscriber device previously associated with the virtual phone number. A unique identification, associated with a guest network address, is provided from the subscriber device to the interface module. The guest network address is associated with a guest device. The guest network address, associated with the unique identification, is retrieved through the interface module. A virtual session is hosted, on the interface module, between the subscriber device and the guest device.

In accordance with an embodiment of the present invention, a computer-implemented system includes an interface module for connecting to a virtual phone number from a guest device having a guest network address. The system also includes an identification module for determining a unique identification associated with the guest network address. The interface module is configured for determining whether a subscriber device associated with the virtual phone number is available to receive a call. Also, the interface module is configured to transmit the unique identification to the subscriber device associated with the virtual phone number, If the subscriber device is available to receive the call, the interface module hosts a virtual session between the subscriber device and the guest device.

In accordance with aspects of the present invention, the system further includes

a call center having an incoming call controller that controls incoming guest calls by placing each guest call in an order and assigning the guest calls to subscribers.

In accordance with aspects of the present invention, the availability of the subscriber device is determined by the status of any existing virtual session combined with information from a call center which communicates with the interface module.

### BRIEF DESCRIPTION OF THE FIGURES

These and other characteristics of the present invention will be more fully understood by reference to the following detailed description in conjunction with the attached drawings, in which:

FIG. 1 is a schematic view of a communication network system according to an embodiment of the present invention;

FIG. 2 is a schematic view of a communication network system including a call center according to one aspect of the present invention;

FIG. 3 is a flow chart of an anonymous virtual phone call process including enablement, hosting, and a follow-up call according to one aspect of the present invention;

FIG. 4 is a flow chart of the subscriber availability process according to one aspect of the present invention;

FIG. 5 is a flow chart of the process of a subscriber calling a guest back anonymously according to one aspect of the present invention;

FIG. 6 is a flow chart of the process of a guest texting a subscriber anonymously according to one aspect of the present invention;

FIG. 7 is a flow chart of the process of a subscriber texting a guest back anonymously according to one aspect of the present invention; and

FIG. 8 is a schematic view of a computing device according to one aspect of the present invention.

### DETAILED DESCRIPTION

An illustrative embodiment of the present invention relates to a system and method for hosting virtual sessions between a subscriber at his/her subscriber device (e.g., a telephone) and a guest at his/her guest device. The virtual session is hosted on a virtual phone number server in such a way that allows the guest's identity and guest network address as well as the subscriber's identity and subscriber network address to be maintained mutually anonymous from each other. Only an intermediary trusted entity knows information related to the actual network addresses and identities.

Certain illustrative systems and methods described herein utilize a unique identification (ID) assigned to each guest network address related to a particular virtual phone number assigned to each subscriber. The unique ID is a unique number related to each virtual phone number. Each virtual phone number represents the subscriber network address while the unique ID represents the guest network address. More particularly, the unique ID represents the guest network address related to a particular virtual phone number. For example, there could be two identical unique IDs respectively related to two different virtual phone numbers.

Accordingly, when establishing a virtual session from the guest to the subscriber, the virtual phone number server sends the unique ID, rather than the guest network address, to the subscriber. Similarly, when establishing virtual sessions from the subscriber to the guest, the virtual phone number server utilizes the subscriber's virtual phone number, rather than the subscriber's network address such as a landline or other network address, to make the call or send the message. Alternatively, the virtual phone number for the subscriber is a virtual network address such as an email, website, IP address, etc.

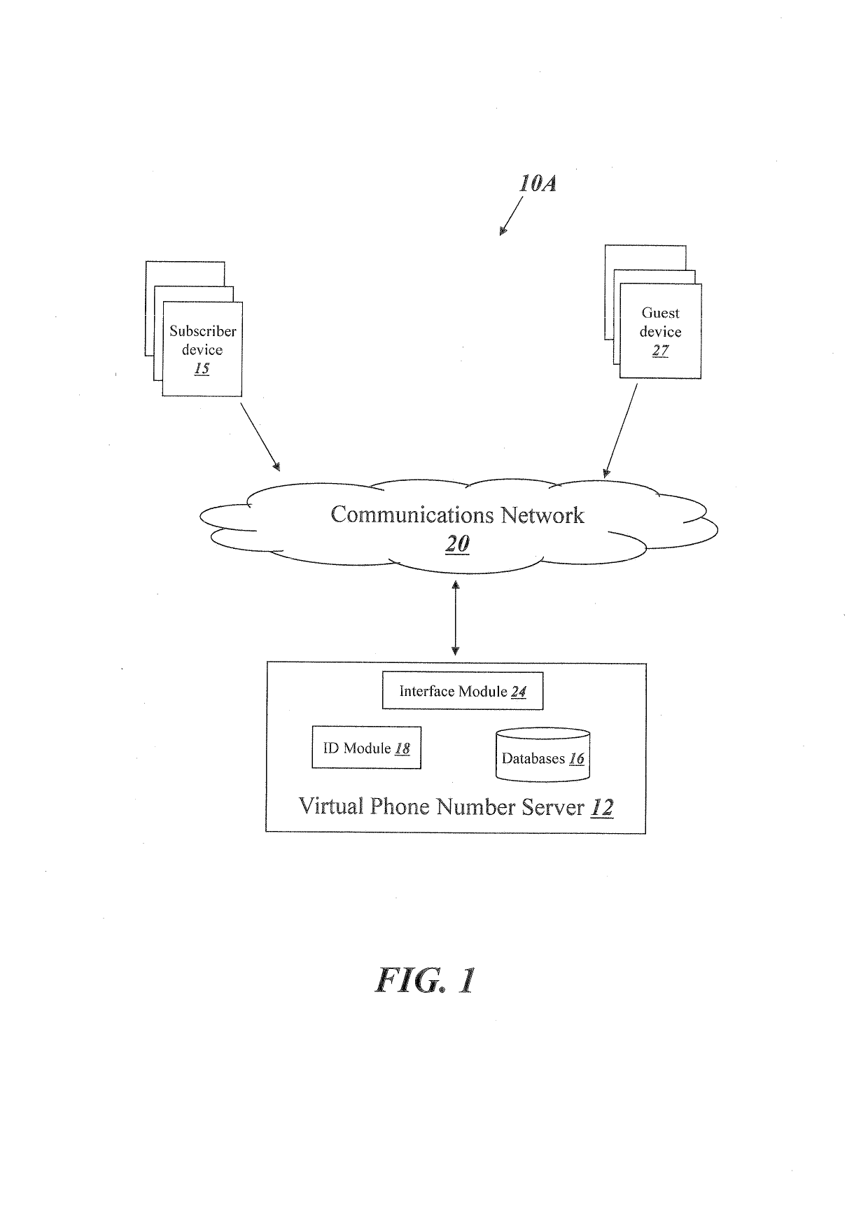

FIGS. 1 through 8, wherein like parts are designated by like reference numerals throughout, illustrate example embodiments of a system and method for providing virtual sessions such as call services for establishing communication between a subscriber (subscriber device) and a guest (guest device) according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, in a manner still in keeping with the spirit and scope of the present invention.

FIG. 1 depicts a system 10A that includes a virtual phone number server 12, a communications network 20 (e.g., the PSTN, the Internet or any other suitable network) and two users participating in a session such as a telephone communication (i.e., a phone call). The users are designated as a subscriber having a subscriber device 15 and a guest having a guest device 27 for the purpose of this illustration.

The virtual phone number server 12 includes an identification (ID) module 18 configured to assign unique identifiers (IDs) to the guest devices 27 of guests the first time they call a specific subscriber device 15. The virtual phone number server 12 is also configured to communicate with the subscriber device 15 at a pre-registered subscriber network address. In order to originate a call to a subscriber device 15, a guest uses his or her guest device 27 (e.g., telephone) to dial the subscriber's virtual phone number. The communications network 20 routes the call to the virtual phone number server which assigns an ID to the guest device 27 and creates a private record associating that ID with the guest's actual network address (of the guest device 27). The virtual phone number server 12 forwards the call to the subscriber device 15, conveying the guest's ID, but not the guest's actual network address (of the guest device 27). During this call, neither user is knowledgeable of the other user's actual network address; however the guest can reach the same subscriber again in the future by dialing or connecting with the subscriber's sane virtual phone number. The subscriber can reach the guest without knowing the guest's network address by calling the virtual phone number server 12 and submitting the guest's ID number to the server 12 (the virtual phone number server 12 also receiving the subscriber's virtual phone number). The virtual phone number server 12 references its private record for the guest's ID and transfers the call to the guest's actual network address. In this way, voice calls, texts, multi-media messages, data, and the like, can be conveyed anonymously between users.

The virtual phone number server 12 also includes one or more databases 16 containing a variety of information for enabling the functions described herein. For example, the one or more databases 16 can include information relating to the subscriber devices 15 (e.g., subscriber network addresses such as telephone numbers of the subscriber devices 15), as well as a virtual phone number associated with each subscriber device 15. The one or more databases 16 additionally can store guest network addresses such as telephone numbers of guest devices 27, as well as a unique identification (ID) assigned to each particular guest device 27 for a specific virtual phone number.

The virtual phone number server 12 also includes an interface module 24 configured to determine if a subscriber device 15 is currently engaged in a session such as a phone call. The interface module 24 is additionally configured to indicate that a particular subscriber device 15 is currently engaging in a session such as a virtual phone call hosted on the virtual phone number server 12, e.g., in order to help avoid collisions at the subscriber devices 15 due to additional incoming telephone calls being conveyed to a subscriber device 15 that is already engaged in a virtual session (e.g., phone call) hosted on the virtual phone number server 12.

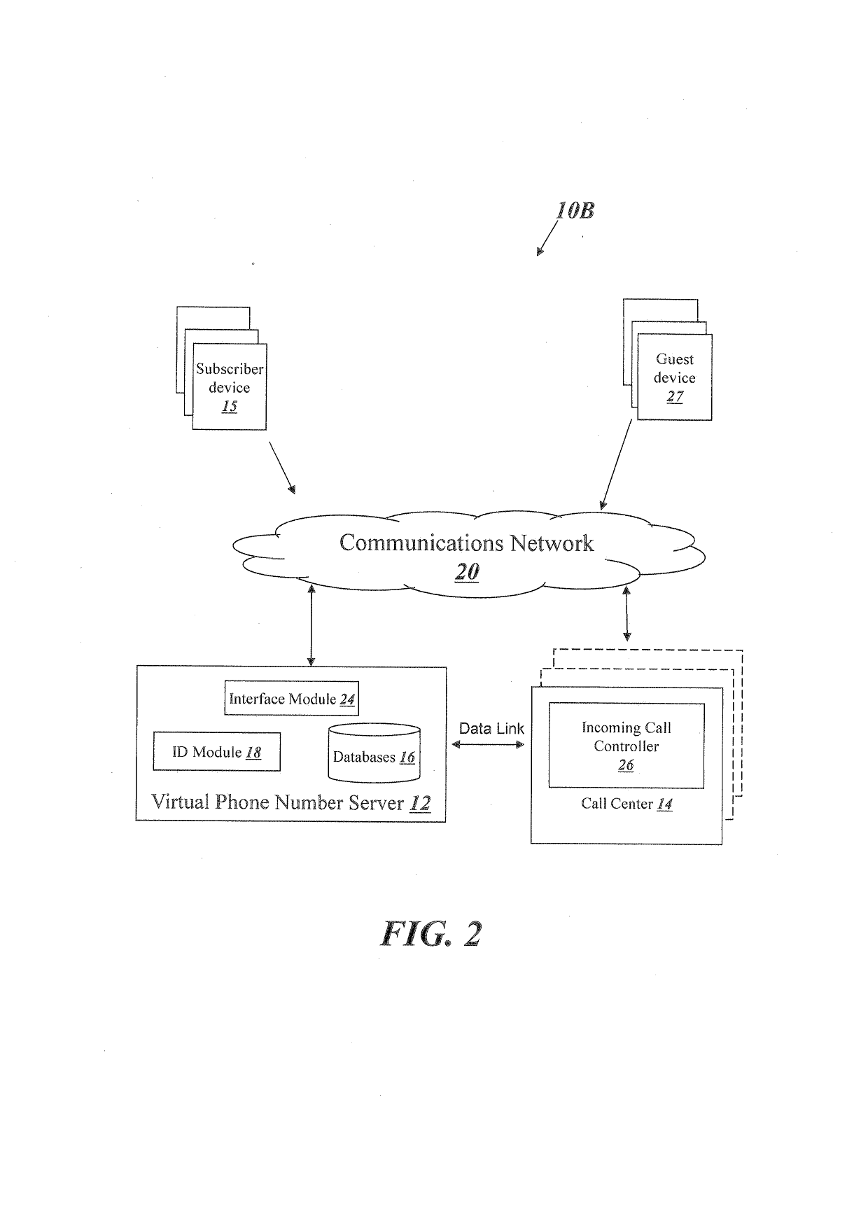

FIG. 2 depicts a system 10B that includes a virtual phone number server 12 and one or more call centers 14 in communication via a communications network 20 (e.g., the PSTN, the Internet or any other suitable network) with subscriber devices 15 and guest devices 27. In this example, the subscribers are operators of the call centers 14. The subscriber devices 15 are located remotely from the call center 14 so the subscribers communicate with the call center 14 through a communications network 20. Alternatively, the system 10B can operate without a call center 14 as shown in FIG. 1. The virtual phone number server 12 includes an identification (ID) module 18 configured to assign unique identifiers (IDs) to guest devices 27 used by guests of the call center 14. In addition to communicating with the call centers 14, the virtual phone number server 12 is also configured to communicate with the subscribers at their respective subscriber devices 15 (e.g., personal mobile phones, virtual networks, other communication devices, etc.).

The virtual phone number server 12 includes one or more databases 16 containing a variety of information for enabling the functions described herein. For example, the one or more databases 16 can include information relating to the subscriber devices 15 (e.g., subscriber network address such as phone numbers of the subscriber devices 15), as well as a virtual phone number associated with each subscriber device 15. The one or more databases 16 can additionally store guest network addresses such as telephone numbers of guest devices 27 used by guests, or more particularly customers of the call centers 14. The databases 16 can also store unique identification (ID) numbers assigned to each particular guest device 27 for a specific virtual phone number.

The call center 14 includes an incoming call controller 26 that controls incoming phone calls (e.g., which places phone calls in an order/queue, manages phone calls, assigns phone calls to particular subscribers, etc.) and performs other standard controlling and managing functions in call centers 14, as would be appreciated by one of skill in the art.

The virtual phone number server 12 is configured to receive sessions addressed to virtual phone numbers from guests on guest devices 27 and transmit the virtual sessions to subscribers on their subscriber devices 15 in a manner that maintains the anonymity of both (a) the subscriber network address of the subscriber, and (b) the guest network address of a guest placing the virtual call (and their respective devices 15, 27). Similarly, the virtual phone number server 12 is configured to allow subscriber devices 15 to initiate sessions using a unique identification (ID) number assigned to a guest, in a manner that maintains the anonymity of both (a) the subscriber network address of the subscriber, and (b) the guest network address of a guest receiving the virtual call (and their respective devices 15, 27).

The virtual phone number server 12 additionally includes an interface module 24 configured to query the incoming call controller 26 of the call center 14 via a data link. This query is for determining if a subscriber device 15 is currently engaged in another session such as a phone call with a different guest. The interface module 24 is additionally configured to instruct the incoming call controller 26, via the data link, to indicate that a particular subscriber device 15 is currently engaging in a virtual phone call hosted on the virtual phone number server 12, e.g., in order to help avoid collisions at the subscriber devices 15 due to incoming telephone calls at the call center 14 being conveyed to a subscriber device 15 that is already engaged in a virtual session (e.g., phone call) hosted on the virtual phone number server 12.

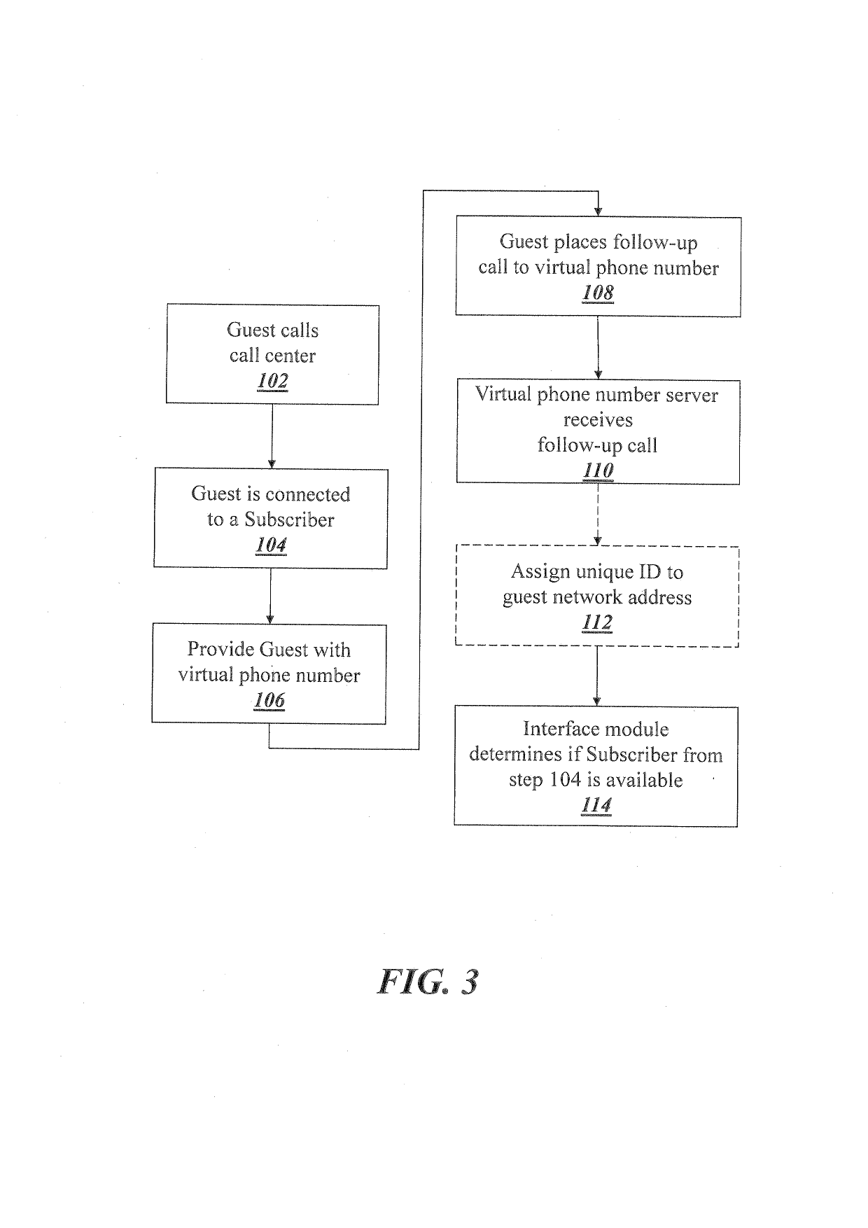

FIG. 3 depicts a method according to an example embodiment of the present invention for enabling and hosting an anonymous follow-up virtual session such as a phone call between a subscriber and a guest after an initial call between that same subscriber and the same guest. In general, guests in need of a service will call the call center 14 at a published network address such as a phone number (step 102). Then, the guest is greeted by an automated message, occasionally asked to complete one or more initial steps (e.g., preauthorization for billing, verification of identity, etc.), and then placed in a queue to speak to a subscriber. Once the guest rises to the top of the queue, the guest is connected to a subscriber (step 104). The subscriber assigned to the guest can be assigned randomly, based on an algorithm, etc., as would be readily appreciated by one of skill in the art. The subscriber at his/her subscriber device 15 and the guest at his/her guest device 27 (e.g., phone) then engage in a discussion. In one example, at some point during the phone call, the subscriber provides the guest with a virtual phone number that is specifically assigned to the subscriber, which the guest can call or text in the future to reach the subscriber for a follow-up discussion (step 106). At the end of the phone call, a billing record optionally can be generated.

In the illustrative embodiments, according to the present invention, the virtual phone number that is provided to the guest in step 106 is a virtual phone number provided by, and hosted on, the virtual phone number server 12. Furthermore, the virtual phone number provided by the subscriber in step 106 is a virtual phone number that is assigned specifically to that particular subscriber's subscriber device 15. For example, the one or more databases 16 optionally can include virtual phone numbers and a specific subscriber device 15 (e.g., identified according to the subscriber network address such as a phone number, etc.) that is assigned to each virtual phone number. As such, when the guest connects with or calls the virtual phone number, provided in step 106, for a follow-up conversation, the guest is directed to the virtual phone number server 12, which can then transmit the virtual phone call to the specific subscriber device 15 assigned to the called virtual phone number. This enables guests to follow up with subscribers, with which they have previously spoken, without the subscriber having to provide the subscriber network address of his or her subscriber device 15.

Continuing with FIG. 3, at some point after the initial conversation initiated by the guest in step 102 has been concluded, the guest can connect with the virtual phone number to follow up with the subscriber (step 108). The virtual phone number server 12 receives the virtual phone call placed by the guest through at least one input device (step 110). Upon receiving the virtual phone call, the ID module 18 searches the one or more databases 16 to determine if the guest network address being used by the guest to make the call/connection on the guest device 27 is already associated with a unique ID. If so, then the method proceeds from step 110 to step 114. If not, then the ID module 18, using at least one processor, assigns a unique ID to the guest network address being used by the guest to make the virtual phone call (step 112). The virtual phone number server 12 stores the unique ID and the corresponding guest network address in the one or more databases 16, e.g., for future reference and use. As such, the one or more databases 16 include guest network addresses such as telephone numbers (e.g., mobile telephone numbers, landline telephone numbers, etc.), as well as a unique ID associated with each guest network address for a specific virtual phone number in the one or more databases 16. As just one non-limiting example, in the illustrative embodiments, the ID module 18 can use at least one processor to generate a multiple digit code that is uniquely assigned to the particular guest network address being used by the guest to make the call or connection. One of skill in the art will appreciate a wide variety of other unique IDs that can be assigned to guest network addresses. All such alternatives and modifications are contemplated within the scope of the present invention.

Once the virtual phone number server 12 receives the guest's follow-up call or connection to the virtual phone number in step 110, the virtual phone number server 12 determines if the subscriber device 15 associated with that particular virtual phone number (i.e., the subscriber from step 104) is available to receive a phone call (step 114). Specifically, step 114 can include the virtual phone number server 12 interfacing with the call center 14 via the data link to determine if the particular subscriber device 15 associated with the dialed virtual phone number is currently on another call or session. For example, the interface module 24 can send, through at least one output device, a request to the call center 14 inquiring into the current status of the subscriber device 15 from step 104. Optionally, in step 114, the virtual phone number server 12 can also communicate with the call center 14, via the data link, to verify that the guest making the call is a valid guest (e.g., a billable guest or customer, etc.).

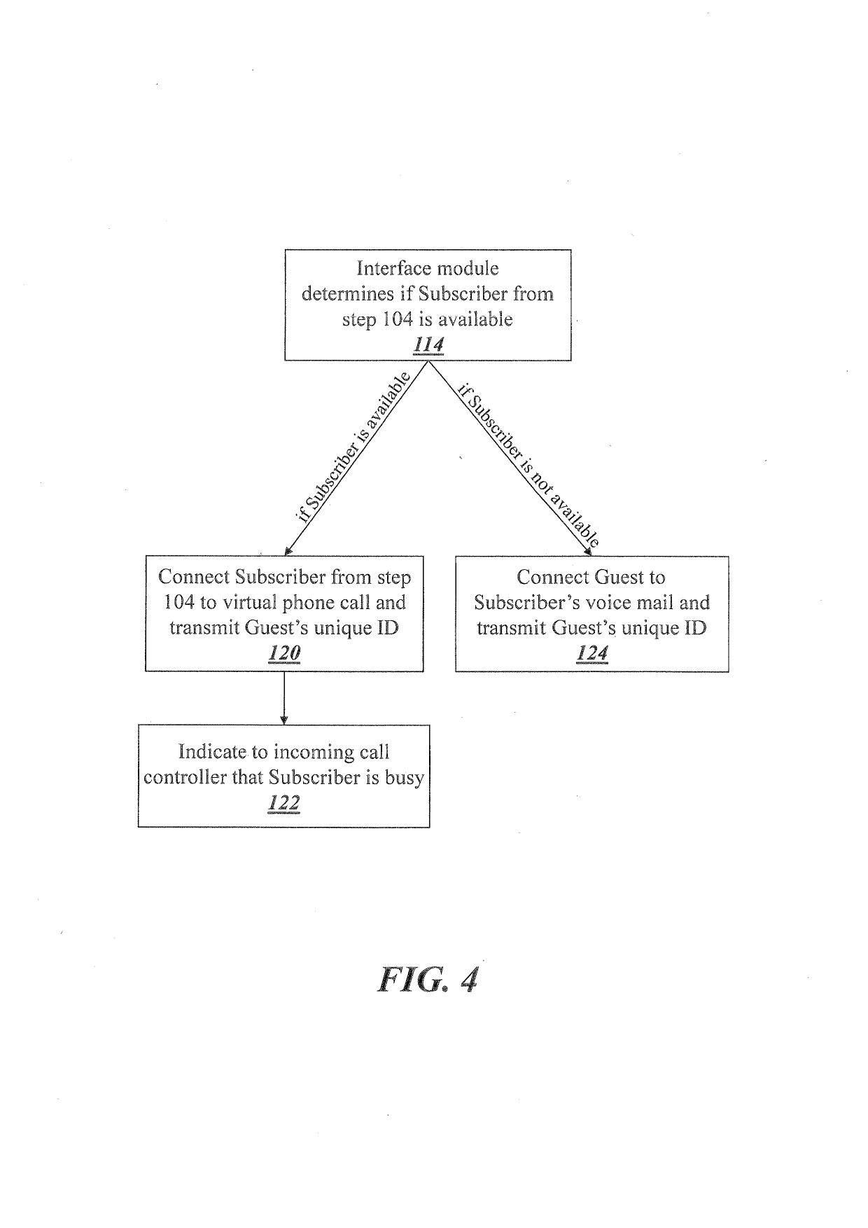

Turning now to FIG. 4, if the subscriber device 15 assigned to the virtual phone number, used by the guest to make the follow-up call, is available to receive the follow-up call (e.g., as indicated by the call center 14 via the communications network 20), then the virtual phone number server 12 connects the subscriber device 15 of the subscriber from step 104 to the virtual phone call and transmits the guest's unique ID to the subscriber device 15 (step 120). Once the subscriber device 15 is connected to the virtual phone call, the virtual phone number server 12 hosts the virtual session (e.g., a voice-over-IP call, as would be appreciated by one of skill in the art) between the guest on the guest device 27 and the subscriber on the subscriber device 15. For example, this can include providing input and output streams to both the guest device 27 (e.g., telephone) and the subscriber device 15 (step 120). To avoid call collision, once the subscriber device 15 connects to the virtual phone call in step 120, the interface module 24 sends an instruction to the incoming call controller 26 via the data link to indicate that the subscriber device 15 is busy and unavailable to take additional calls until further notice (step 122). This prevents non-virtual phone calls from being transferred to the subscriber by the call center 14 during the subscriber's virtual session such as a phone call. Once the virtual phone call is concluded, the interface module 24 can send the incoming call controller 26 an indication that the subscriber from step 104 is once again available to receive calls. Furthermore, once the virtual phone call is concluded, the interface module 24 optionally sends the call center 14 a billing statement or record, for purposes of allowing the call center 14 to bill virtual sessions hosted on the virtual phone number server 12.

As described previously herein, the step 120 includes providing the subscriber device 15 with the unique ID of the guest that initiated the virtual phone call. This allows the subscriber, for example, to retrieve his/her notes from previous calls with the guest. In this manner, the guest is enabled to be re-connected with the subscriber from step 104 for the follow-up discussion, without need to reiterate the previous discussions. Accordingly, the interface module 24 allows the incoming call controller 26 to account for virtual sessions in the same system used to account for other sessions such as phone calls (e.g., landline calls, mobile calls, etc.).

Continuing with FIG. 4, if the subscriber from step 104 alternatively is determined in step 114 to be unavailable (i.e., on another session such as a phone call), then the guest is connected to the voice mail of the subscriber from step 104 (step 124), thereby allowing the guest to leave a voicemail message. In illustrative embodiments, the voicemail message is accompanied by the guest's unique ID. For example, the voicemail message can include an introductory recording from the virtual phone number server 12 stating the unique ID associated with the guest (particularly the guest device 27) who is leaving the voicemail message (e.g., “This voicemail message is from guest 1234.”).

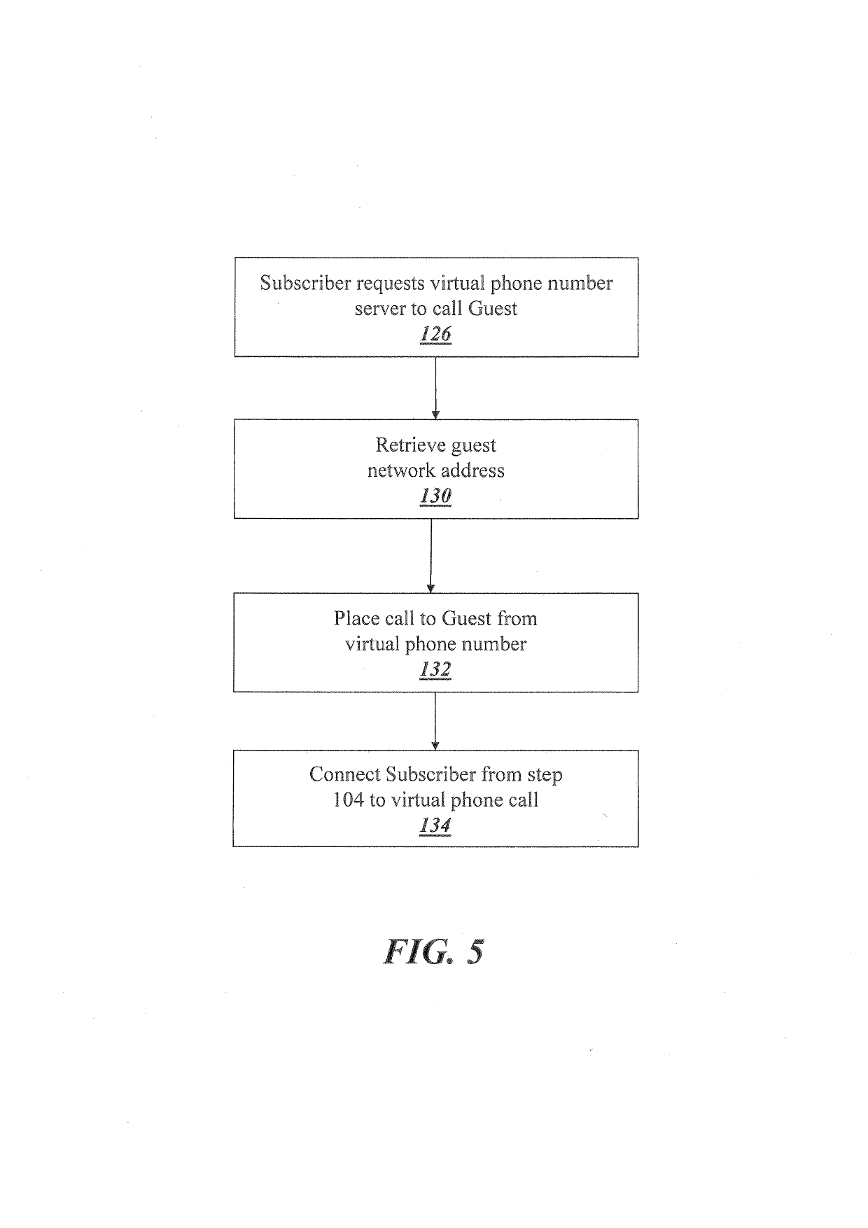

Thus, by referencing the guest's unique ID, the subscriber from step 104 is able to call the guest back without ever knowing the guest's network address such as a phone number. For example, turning now to FIG. 5, the subscriber contacts the virtual phone number server 12 (e.g., calls the virtual phone number server) and provides the unique ID from the voicemail message, thereby requesting the virtual phone number server 12 to initiate a virtual session such as a phone call between the associated guest and the subscriber at his/her subscriber device 15 (step 126). The virtual phone number server 12 thus receives the unique ID and retrieves the guest network address from the one or more databases 16 associated with that unique ID (step 130). Once the guest network address is retrieved by the virtual phone number server 12, the virtual phone number server 12 calls the guest (step 132) from the virtual phone number associated with the subscriber who placed the request in step 126. When the guest answers the call, the guest becomes connected to the virtual phone call (step 134). During the virtual session, the virtual phone call is hosted by the virtual phone number server 12 (e.g., as a voice-over-IP call, as would be appreciated by one of skill in the art). For example, as described previously herein, the virtual phone number server 12 can transmit an input and output audio stream of the virtual phone call to both the subscriber device 15 of the subscriber that placed the request and the guest device 27 (e.g., telephone) of the guest, thereby enabling the subscriber from step 104 to engage in the follow-up communication with the guest based on the voicemail message left by the guest.

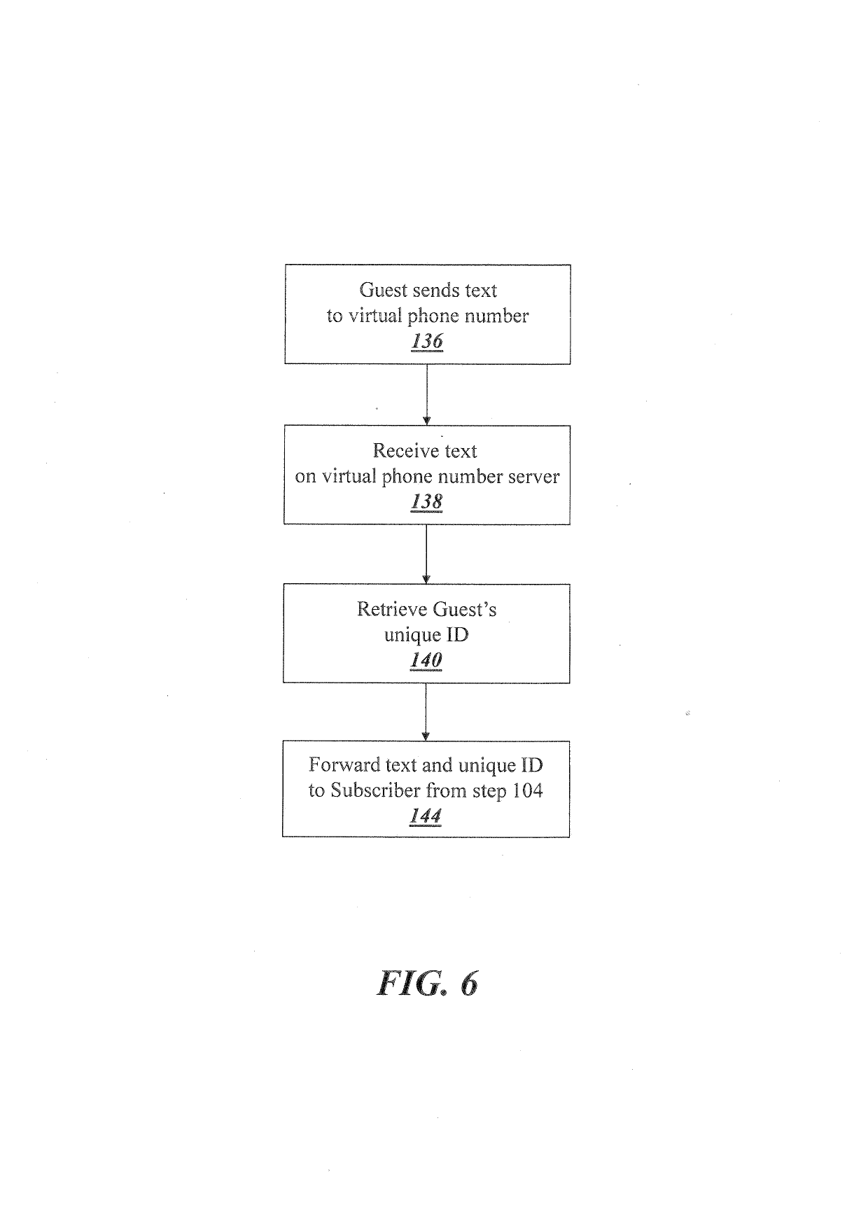

According to yet further illustrative embodiments of the present invention, the guest and the subscriber from step 104 can contact one another for follow-up communication sessions using text (SMS) messages or multi-media (MMS) messages. For example, turning to FIG. 6, once the guest is provided with the virtual phone number in step 106, the guest can send a text (SMS) message to the virtual phone number (step 136). The virtual phone number server 12 receives, through at least one input device, the text message (step 138). The virtual phone number server 12 queries the one or more databases 16 for a unique ID associated with the guest network address used by the guest device 27 to send the text (SMS) message, and thereby retrieves the unique ID associated with the guest network address used by the guest to send the text (SMS) message (step 140). The virtual phone number server 12 then transmits the content of the text message and the retrieved guest's unique ID, through at least one output device, to the subscriber device 15 associated with the virtual phone number designated as the recipient of the text (SMS) message (step 144). In this manner the subscriber from step 104 receives the text (SMS) message as well as the guest's unique ID.

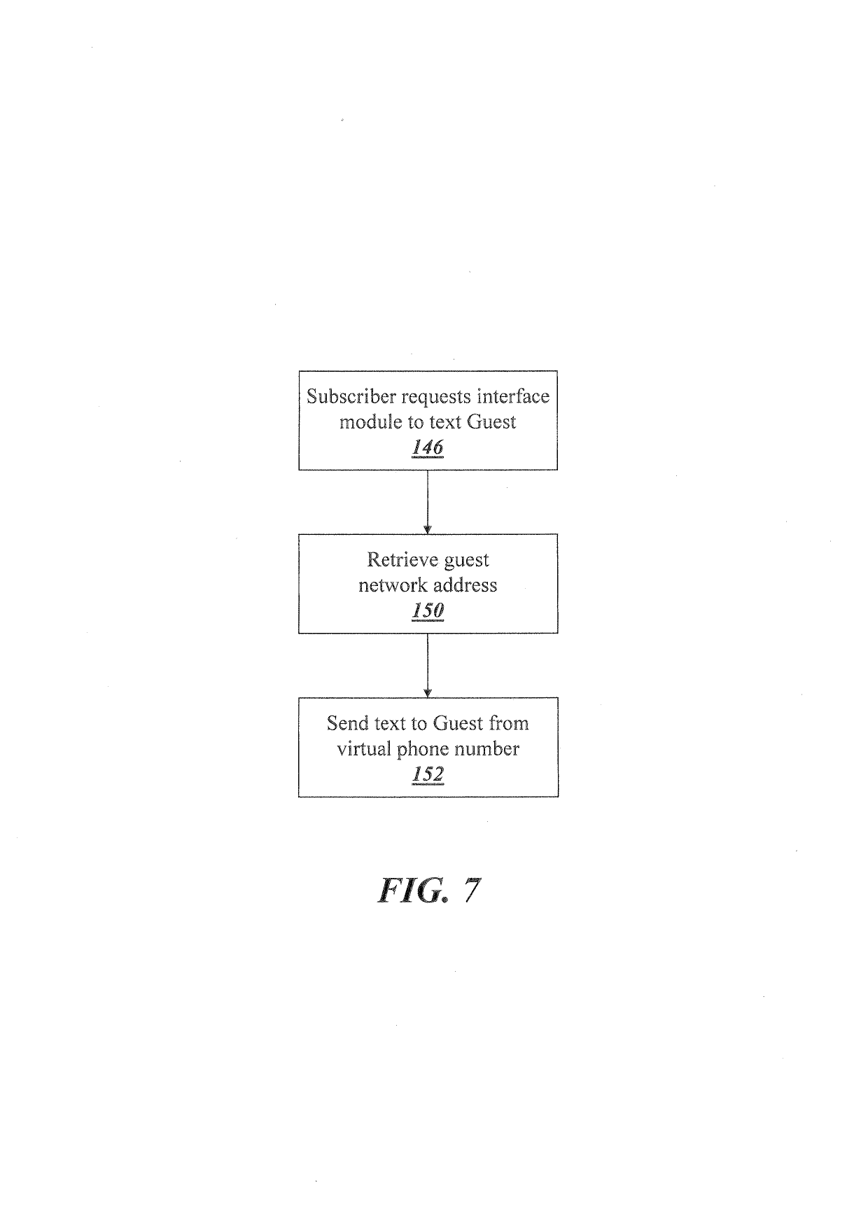

Similarly, the subscriber can respond to the guest (e.g., to the guest's text) by composing and sending the guest a text (SMS) message or a multi-media (MMS) message. For example, as depicted in FIG. 7, the subscriber can request the virtual phone number server 12 to send a text (SMS) message to the guest by composing a message and identifying the guest's unique ID as the intended recipient (step 146). Based on the request, the virtual phone number server 12 retrieves from the one or more databases 16 the guest network address such as the phone number associated with the unique ID contained in the request (step 150). The virtual phone number server 12 then sends the text message to the guest (guest device 27) from the virtual phone number associated with the subscriber (subscriber device 15) that sent the request in step 146 (step 152). The text (SMS) message is thereby delivered to the guest device 27 from the virtual phone number, thereby maintaining the anonymity of the subscriber.

In general, any suitable computing device can implement the system 10A/10B (e.g., the call center 14 and the virtual phone number server 12), as well as the methods described herein. For example, the computing device can include one or more server devices, e.g., logically coupled and in communication with each other. Accordingly, the components (e.g., the modules, controllers, etc.) of FIGS, 1-2 generally can be implemented as executable instructions contained in one or more non-transitory computer readable storage devices included in the computing device, one or more input devices, one or more output devices, etc., as would be appreciated by one of skill in the art.

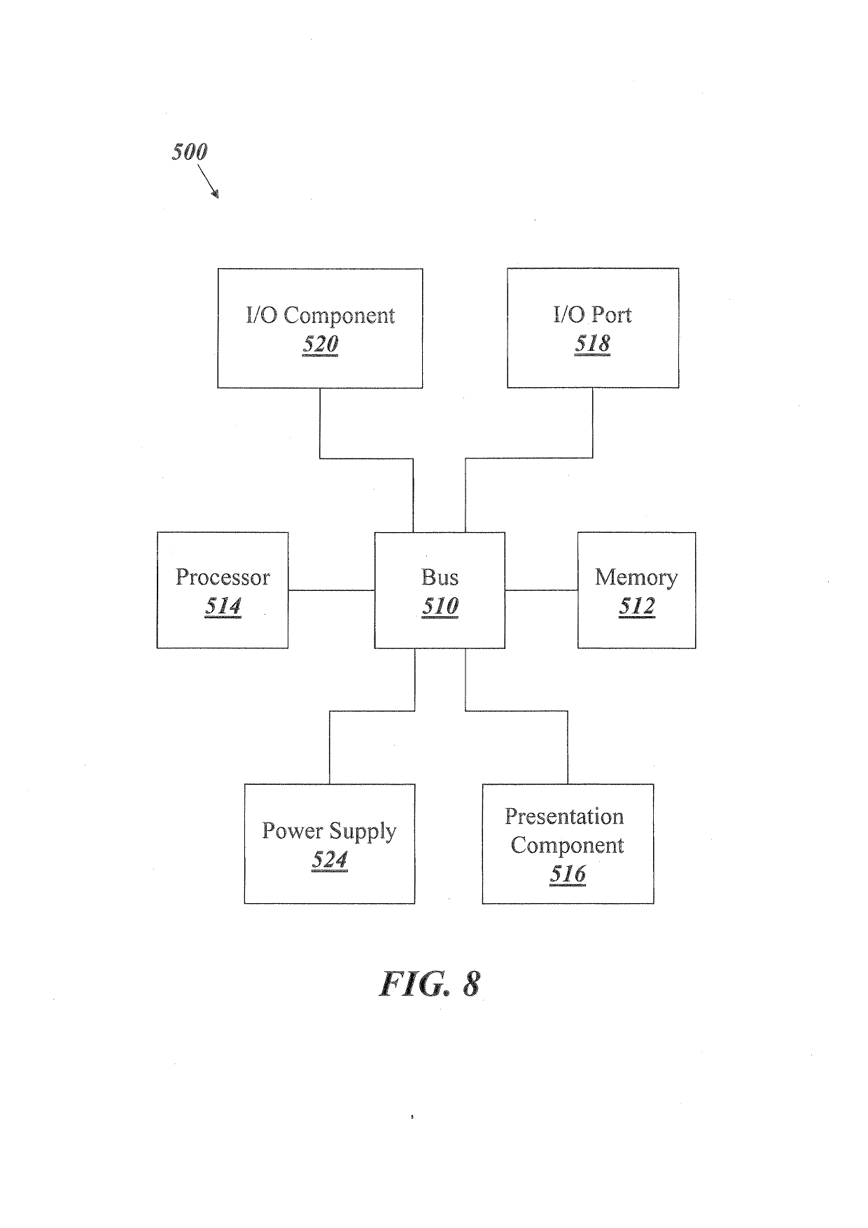

FIG. 8 illustrates an example of a computing device 500 for implementing illustrative methods and systems of the present invention. The computing device 500 is merely an illustrative example of a suitable computing environment and in no way limits the scope of the present invention. A “computing device,” as represented by FIG. 8, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 8 is merely illustrative of an exemplary computing device that can be used to implement one or more embodiments of the present invention, and in no way limits the invention.

The computing device 500 can include or interact with a variety of computer-readable media. For example, computer-readable media can include Random Access

Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage 5 devices that can be used to encode information and can be accessed by the computing device 500.

The memory 512 can include computer-storage media in the form of volatile and/or nonvolatile memory. The memory 512 can be removable, non-removable, or any combination thereof.

Exemplary hardware devices are devices such as hard drives, solid-state memory, optical-disc drives, and the like.

The computing device 500 can include one or more processors 514 that read data from components such as the memory 512, the various I/O components 520, etc.

Presentation component(s) 516 present data indications to a user or other device. Exemplary presentation components 516 include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, blue-tooth device, networking device, and the like.

One of skill in the art will appreciate a wide variety of ways to modify and alter the system 10A/10B of FIGS. 1-2, as well as the various components with which it interacts. For example, the one or more databases 16 can be implemented according to any number of suitable database structures. Furthermore, some or all of the information contained in the one or more databases 16 alternatively can be stored in one or more remote databases (e.g., cloud databases, virtual databases, and any other remote database). Additionally, although the components of FIGS. 1-2 are depicted as discrete blocks and elements, in fact the system 10A/10B may be implemented in such a way that multiple depicted modules, controllers, or other components are implemented with just a single module, controller, or component. Similarly, in some embodiments it may be desirable to implement the system 10A/10B using multiple iterations of the depicted modules, controllers, and/or other components, as would be appreciated by one of skill in the art. Furthermore, while some modules and components are depicted as included within the system 10A/10B, it should be understood that, in fact, any of the depicted modules alternatively can be excluded from the system 10A/10B and included in a different system. One of skill in the art will appreciate a variety of other ways to expand, reduce, or otherwise modify the system 10A/10B upon reading the present specification.

The example embodiments described herein enable numerous benefits. For example, the virtual phone numbers provided herein hosted by the virtual phone number server 12 can maintain mutual anonymity while permitting each user (e.g., guest and subscriber) to originate and receive sessions. Each user's actual network address or more specifically phone number is kept private. Additionally, the virtual phone number server 12 (e.g., which can be implemented at least in part as an application programming interface) supports better integration with the “back office” (e.g., the incoming call controller 26) of the call center 14. In some embodiments, virtual sessions (i.e., voice calls and text (SMS) messages) can be authorized in advance by the call center 14. Additionally, voice calls and text messages can be reported by the virtual phone number server 12 to the call center 14 via the data link, thereby enabling the call center 14 to bill the guest for the communications hosted on the virtual phone number server 12.

Overall, the system 10A/10B according to example embodiments of the present invention can enable any or all of the following: (a) calls originated by guest to subscriber; (b) calls originated by subscriber to guest; (c) text messages from guest to subscriber; and (d) text messages from subscriber to guest; (e) multi-media messages (MMS) from guest to subscriber; (0 multi-media messages from subscriber to guest; (g) data transmissions from guest to subscriber; and (h) data transmissions from subscriber to guest.

As further possible features, the virtual phone number server 12 can obtain approval from the guest for all purchases. Using the interface module 24, calls flowing through the normal call center channels can be coordinated and better integrated with virtual phone calls over the virtual phone numbers, thereby preventing collisions of calls to a busy subscriber. Additionally, the interface module 24 can be configured to permit supervisors of the subscribers to monitor and intervene on virtual phone calls between the subscriber and guest.

Notably, the virtual phone number server 12 enables subscribers to initiate virtual sessions such as phone calls to guests' telephones (e.g., landline phones, mobile phones, etc.). This is a distinct advantage over known systems, which only permit initiation of voice sessions using a web browser or web application. Furthermore, the virtual phone number server 12 can be enabled to quote prices for services in response to real time instructions provided by the call center 14, as would be appreciated by one of skill in the art upon reading the present specification. Furthermore, the virtual phone number server 12 and the interface module 24 can be configured to include features for managing and deterring guest and subscriber fraud. Additionally, the virtual phone number server 12 and interface module 24 can be configured to permit a subscriber to configure call routing individually for each guest. For example, a subscriber can configure a virtual phone number to route selected guests to voice mail, and other guests to specific phone numbers, and still other guests can be blocked from making future calls.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer-implemented method, comprising:
receiving, through an interface module, a call to a virtual phone number from a guest device having a guest network address;
determining, using an identification module, a unique identification associated with the guest network address;
determining, through communication using the interface module, that a subscriber device associated with the virtual phone number is available to receive a virtual session;
transmitting, through the interface module, the unique identification to the subscriber device associated with the virtual phone number;
hosting, on the interface module, the virtual session between the subscriber device and the guest device; and
upon initiation of the virtual session, outputting through the interface module an indication that the subscriber device is not available.

2. The method of claim 1, further comprising integrating the virtual session with a call center to provide synchronization.

3. The method of claim 2, wherein availability of the subscriber device is determined by a status of an existing virtual session combined with information from the call center which communicates with the interface module.

4. The method of claim 2, further comprising integrating the virtual session with the call center to authorize billing and/or accounting.

5. The method of claim 2, further comprising integrating the virtual session with the call center to authorize a service.

6. The method of claim 1, wherein the virtual session is a telephone communication.

7. The method of claim 1, wherein the virtual session is a text message (SMS).

8. The method of claim 1, wherein the virtual session is a multi-media message (MMS).

9. The method of claim 1, wherein the virtual session is a data transmission.

10. The method of claim 1, wherein the unique identification is a distinctive number for each virtual phone number.

11. The method of claim 10, wherein the determination of the unique identification associated with the guest network address is created when the guest network address is first used with the virtual phone number.

12. The method of claim 1, further comprising storing, on one or more databases, the unique identification associated with the guest network address and the virtual phone number associated with the subscriber device.

13. The method of claim 1, wherein the guest network address is a telephone number.

14. A computer-implemented method, comprising:
receiving, through an interface module, a call to a virtual phone number from a subscriber device associated with the virtual phone number;
authenticating the subscriber device as the subscriber device previously associated with the virtual phone number;
providing, from the subscriber device to the interface module, a unique identification associated with a guest network address wherein the guest network address is associated with a guest device;
retrieving, through the interface module, the guest network address associated with the unique identification; and
hosting, on the interface module, a virtual session between the subscriber device and the guest device.

15. The method of claim 14, wherein the virtual session is a telephone communication.

16. The method of claim 14, wherein the virtual session is a text message (SMS).

17. The method of claim 14, wherein the virtual session is a multi-media message (MMS).

18. The method of claim 14, wherein the virtual session is a data transmission.

19. The method of claim 14, wherein the guest network address is a telephone number.

20. A computer-implemented system, comprising:
an interface module for connecting to a virtual phone number from a guest device having a guest network address; and
an identification module for determining a unique identification associated with the guest network address;
the interface module configured for determining whether a subscriber device associated with the virtual phone number is available to receive a call;
the interface module configured to transmit the unique identification to the subscriber device associated with the virtual phone number;
wherein if the subscriber device is available to receive the call, the interface module hosts a virtual session between the subscriber device and the guest device.

21. The system of claim 20, further comprising a call center having an incoming call controller that controls incoming guest calls by placing each guest call in an order and assigning the guest calls to subscribers.

22. The system of claim 20, wherein availability of the subscriber device is determined by the status of any existing virtual session combined with information from a call center which communicates with the interface module.

23. The system of claim 20, wherein the unique identification is a distinctive number for each virtual phone number.

24. The system of claim 23, wherein the determination of the unique identification associated with the guest network address is created when the guest network address is first used with the virtual phone number.

25. The system of claim 20, wherein the guest network address is a telephone number.
